(19) United States
(12) Patent Application Publication
(10) Pub. No.: US 2021/0360887 A1
(43) Pub. Date: Nov. 25, 2021

(54) SOILLESS GROWING MODULE AND BUILDING SYSTEM

(71) Applicant: Nexgarden LLC, Portland, OR (US)

(72) Inventors: Hugh Neri, Portland, OR (US); Leila Skye Pearson, Portland, OR (US)

(21) Appl. No.: 16/754,726

(22) PCT Filed: May 25, 2018
(86) PCT No.: PCT/US2018/034770

§ 371 Date: Apr. 8, 2020

Related U.S. Application Data
(60) Provisional application No. 62/570,213, filed on Oct. 10, 2017.

(51) Int. Cl. A01G 31/06

(52) U.S. Cl. CPC A01G 31/06; A01G 2031/006

(57) ABSTRACT

The present application relates generally to soilless growing systems (100), such as aeroponic and hydroponic systems, and specifically to modular structures for constructing soilless farms. A soilless farming (100) unit may include a plurality of root chambers (6) for growing plants in a growing zone enclosed by a shell (8), a nutrient delivery system (300, 320, 330, 340) that moistens plant roots in the plurality of root chambers (6), and a plurality of apertures (190) in the shell (8) for connecting the farming unit to an adjacent farming unit via at least one of a fluid conduit (150, 152, 210, 220) and a power supply (230). A soilless growing system (100) may include a building having a perimeter sized to match an arrangement of farming units inside the building. A soilless growing system (100) may be a multi-story building with a plurality of farming units on each story.

### RELATED APPLICATION DATA

This application is a non-provisional of and claims the benefit under 35 U.S.C. § 119(e) of U.S. Provisional Patent Application No. 62/570,213, filed Oct. 10, 2017, the disclosure of which is incorporated by reference herein in its entirety.

### TECHNICAL FIELD

This application relates generally to soilless growing systems, such as aeroponic and hydroponic systems, and specifically to modular structures for constructing multi-story farms for such soilless growing systems.

### BACKGROUND

Alternative farming methods such as soilless farming have advantages over traditional farming methods including improved sanitation, higher yield per square foot, and the ability to produce crops without access to arable land. One challenge that alternative farming methods face is keeping energy consumption low while still maximizing efficiency of vegetable growth. Prior efforts to address this challenge include insulated shipping containers modified for high yield plant production as well as enclosed growing containers housed in a warehouse or other large facility. Such systems continue to use energy and space inefficiently, have high construction costs, and are not aesthetically pleasing.

Accordingly, the present inventors have determined that it would be desirable to develop a soilless growing system with improved features for efficiently growing crops and plants while conserving natural resources used by the system. In addition, the present inventors have recognized a need for such an improved system designed to have a minimal footprint for effective operation in constrained spaces, while also including modular components to build farm structures when available space is abundant. Additional aspects and advantages will be apparent from the following detailed description of example embodiments, which proceeds with reference to the accompanying drawings. It should be understood that the drawings depict only certain example embodiments and are not to be considered as limiting in nature.

### SUMMARY

The soilless growing module and building system disclosed is an alternative farming method aimed at simplicity and efficiency within a limited space or limited resource environment. A fully automated closed loop soilless system (monitoring a number of environmental parameters and connecting to the cloud for remote access and control) grows vegetables in support systems secured within the growing module. The soilless growing module (sized as large as a building wall) may itself provide a load-bearing wall of a modular building system or, alternatively, may be installed on a floor or against a wall of a building structure. Space and energy efficiency may be improved by sizing a building structure to fit an arrangement of modules. Modules can be connected vertically (i.e., one positioned vertically above or below another) and/or horizontally (i.e., one positioned adjacent to another). Modules may be arranged on the perimeter of a building or in the interior of a building. A single level or floor of a building may include perimeter modules around the entire perimeter of the floor as well as interior modules within the perimeter. Multiple levels or floors of a building may include multiple layers of modules, each layer positioned vertically above a lower layer. Modules in a multiple-level building may be connected horizontally to adjacent modules within each level as well as vertically to modules on a level above or below. Improving upon past attempts at alternative farming, these modules are fully enclosed. Each unit (or module) is separated from the interior building space in which farmers work. A building may utilize transparent walls, exposing plants to additional sunlight to supplement artificial lighting such as LED lamps. A building, alternatively, may use opaque walls or panels to reduce temperature fluctuations caused by insolation and to reduce cooling load in the modules or in the building. Because these grow modules have been designed specifically for this purpose, they can be organized to fit into a variety of shapes with appropriate and safe workflow for employees.

One challenge of exploring alternative farming methods is determining how to keep energy consumption low while still maximizing efficiency of vegetable growth. In one approach, allowing natural sunlight into the building instead of using a warehouse or shipping container may decrease LED usage and thereby decrease energy consumption. In another approach, preventing natural sunlight from entering into the building may decrease the burden on climate controls and conditioning and thereby decrease energy consumption. With this same goal, having the grow spaces (also referred to as the growing zone or growing environment) separated from work space of farmers allows for keeping energy consumption low because maintenance of the smaller and more stable growing environment is less energy intensive than regulating space that is shared with humans. These automated grow modules simplify construction of an urban vertical farm because they are specially designed and built for this purpose, streamlining construction by reducing the quantity and cost of on-site materials and labor to build an operable urban farm.

### BRIEF DESCRIPTION OF THE DRAWINGS

FIG. 1 is a perspective view of a growing unit of the present disclosure, shown in relation to an adult human of ordinary size.

FIG. 2 is a perspective view of an assembly of growing units of the present disclosure.

FIG. 3 is a perspective view of a half unit of the present disclosure, shown in relation to an adult human of ordinary size.

FIG. 4 is a top view of a diagram of circular openings in a removable top for a root chamber, according to one embodiment of the present disclosure.

FIG. 5 is a process diagram for a grow space having three root chambers, according to one embodiment of the present disclosure.

FIG. 6 is a schematic showing the connections among farm-wide systems (also referred to as whole building systems), each growing chamber, and each central box (also referred to as a central system), according to one embodiment of the present disclosure.

FIG. 7 is a floor plan for a single level of a multi-level farm, according to one embodiment of the present disclosure.

FIG. 8 is a perspective view of a three-story farm with six growing units (two on each floor), according to one embodiment of the present disclosure.

FIG. 9 is a perspective view of a four-story farm, according to one embodiment of the present disclosure.

FIG. 10 is a schematic showing farm-wide systems within a center console of a growing unit, according to one embodiment of the present disclosure.

FIG. 11 is a perspective view of a growing unit of the present disclosure, according to one embodiment of the present disclosure.

FIG. 12 is a front view of the growing unit of FIG. 11.

FIG. 13 is a rear view of the growing unit of FIG. 11.

FIG. 14 is a top view of the growing unit of FIG. 11.

FIG. 15 is a bottom view of the growing unit of FIG. 11.

FIG. 16 is a left side view of the growing unit of FIG. 11.

FIG. 17 is a right side view of the growing unit of FIG. 11.

FIG. 18 is a perspective view of a soilless farm, according to one embodiment of the present disclosure.

FIG. 19 is a front view of the soilless farm of FIG. 18.

FIG. 20 is a top view of the bottom floor of the soilless farm of FIG. 18.

### DETAILED DESCRIPTION OF EXAMPLE EMBODIMENTS

With reference to the drawings, this section describes particular embodiments and their detailed construction and operation. The embodiments described herein are set forth by way of illustration only and not limitation. Throughout the specification, reference to “one embodiment,” “an embodiment,” or “some embodiments” means that a particular described feature, structure, or characteristic may be included in at least one embodiment of the system or of the components being discussed. Thus appearances of the phrases “in one embodiment,” “in an embodiment,” or “in some embodiments” in various places throughout this specification are not necessarily all referring to the same embodiment. Further, the described features, structures, characteristics, and methods of operation may be combined in any suitable manner in one or more embodiments. In view of the disclosure herein, those skilled in the art will recognize that the various embodiments can be practiced without one or more of the specific details or with other methods, components, materials, or the like. In other instances, well-known structures, materials, or methods of operation are not shown or not described in detail to avoid obscuring more pertinent aspects of the embodiments.

With general reference to the figures, the following disclosure relates generally to an improved soilless growing system 100 that provides a suitable growing environment for plants and crops. The soilless growing system 100 may be partially or entirely enclosed so as to minimize the impact of the outside environment, such as in extreme climates, on the growing plant life. In addition, the system 100 may include one or more access points (e.g., doors) to allow farmers or other personnel to enter and tend to the crops or harvest the crops when ready.

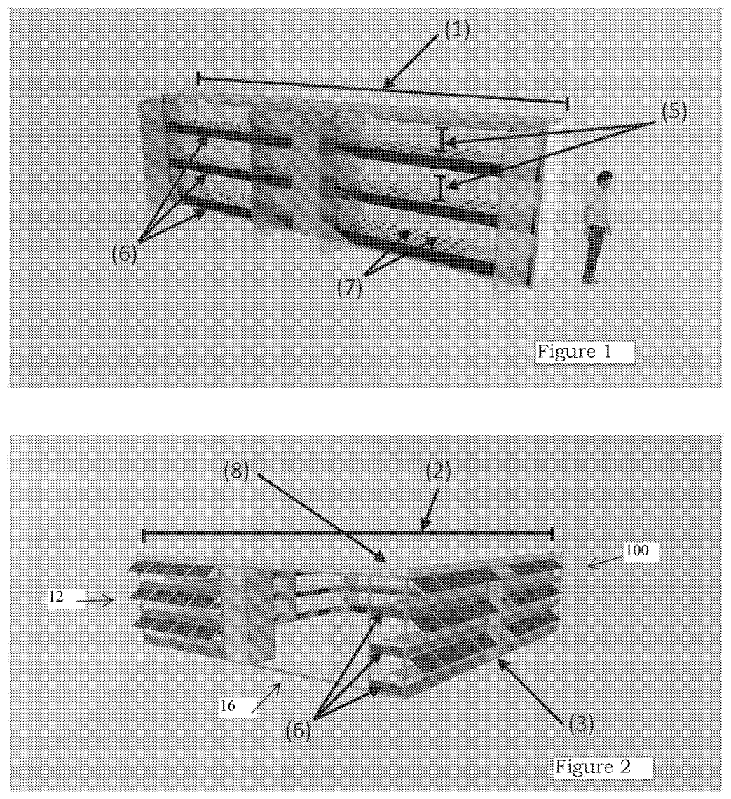

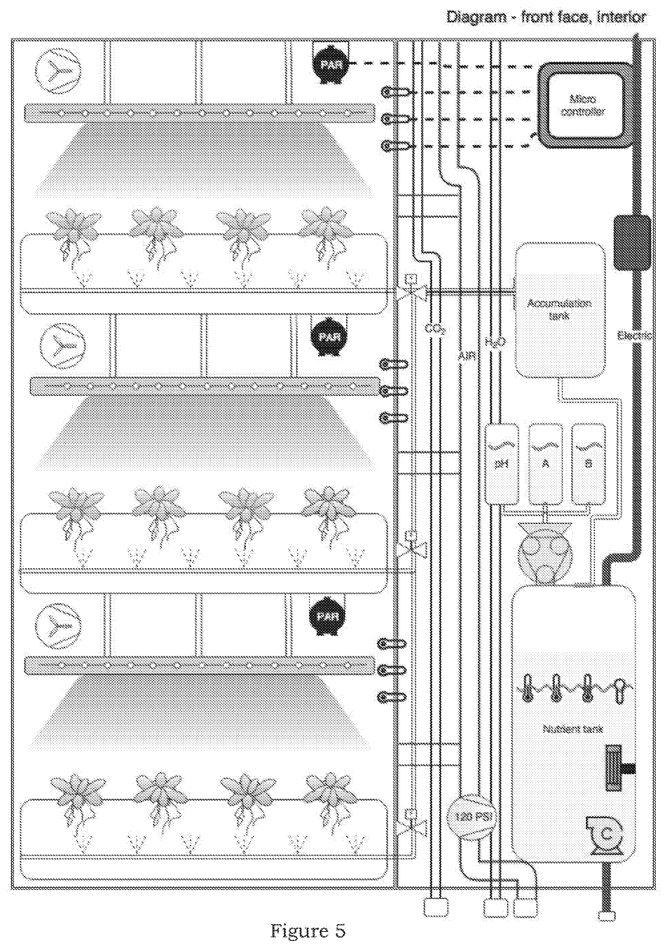

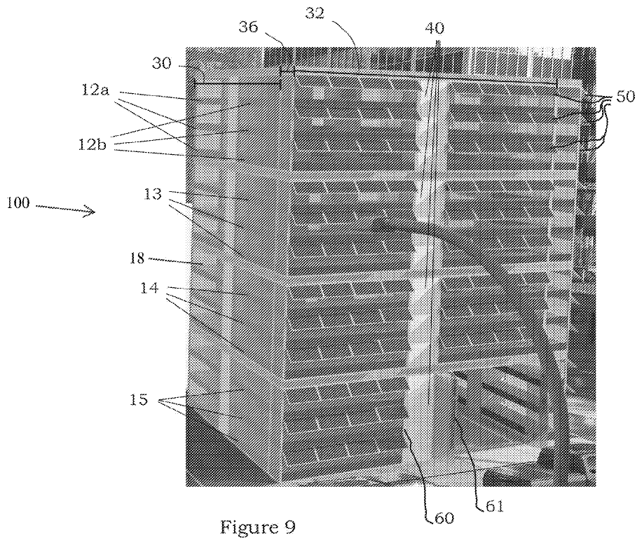

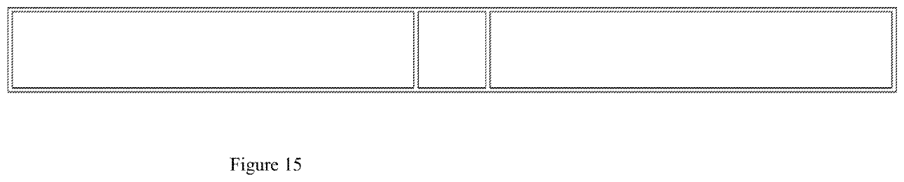

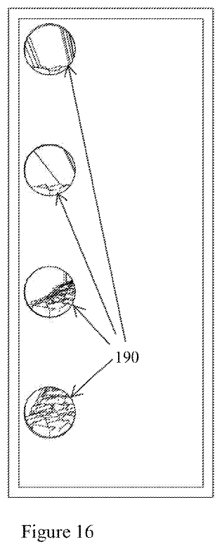

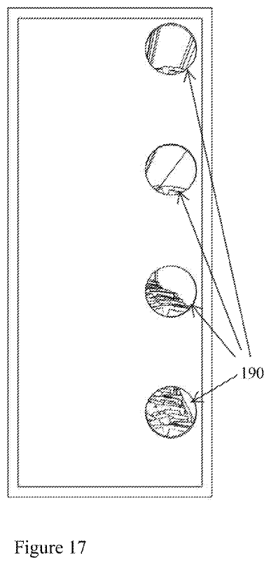

As illustrated in FIGS. 1-20, the soilless growing system 100 (see FIG. 9) includes a variety of modular components that may be arranged to build single- or multi-layered farms for growing plants. As described in further detail below, the soilless growing system 100 may include interconnected systems, such as water, electrical, and/or HVAC (heating, ventilation, and air conditioning) systems that operate between multiple modules to improve overall efficiency of the system. In addition, the components comprising the multi-layered farms are designed to be modular, thereby allowing the system to be dismantled and transported to different sites if necessary. Additional details of these and other embodiments are further discussed below with particular reference to the accompanying figures.

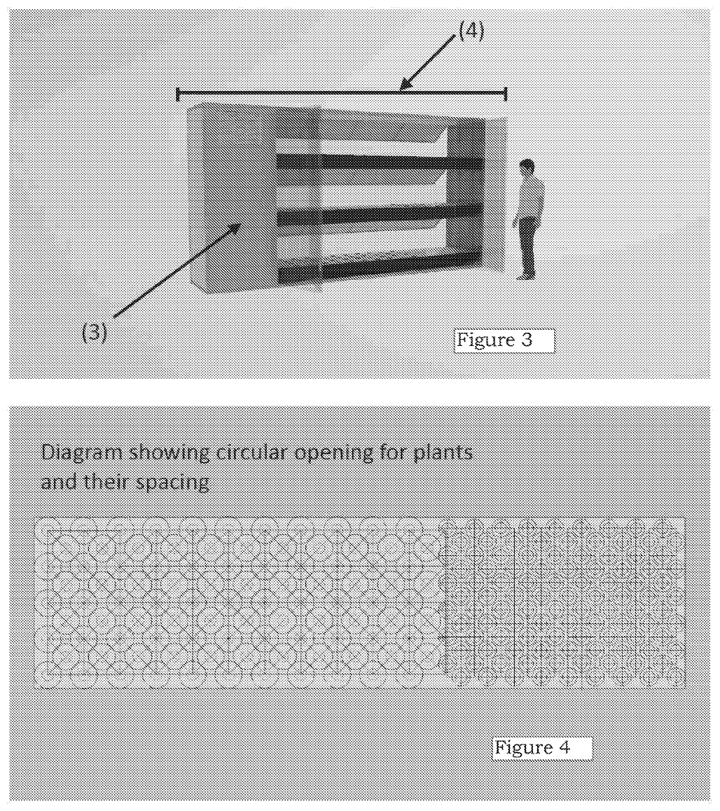

With reference to the embodiments shown in FIGS. 1-6, a single module may be referred to as a unit or module 1, and two or more modules connected together and sharing one or more systems (as described below) may be referred to as a farm 2 as illustrated in FIG. 2. The part of each unit that houses the electronics, plumbing, and connections to farm-wide systems may be referred to as the central box (or console), center box (or console), or connection box (or console) 3. In FIG. 3, a half-sized unit 4 contains a central box 3 and grow space on only one side of it, instead of both sides. In FIG. 2, a half-sized unit 12 is shown adjacent to door access 16. One full-size unit is approximately three feet deep, 36 feet long, and eight feet high. One half-size unit is three feet deep, 19.5 feet long, and eight feet high. The central box in each unit is three feet deep, three feet long, and eight feet high.

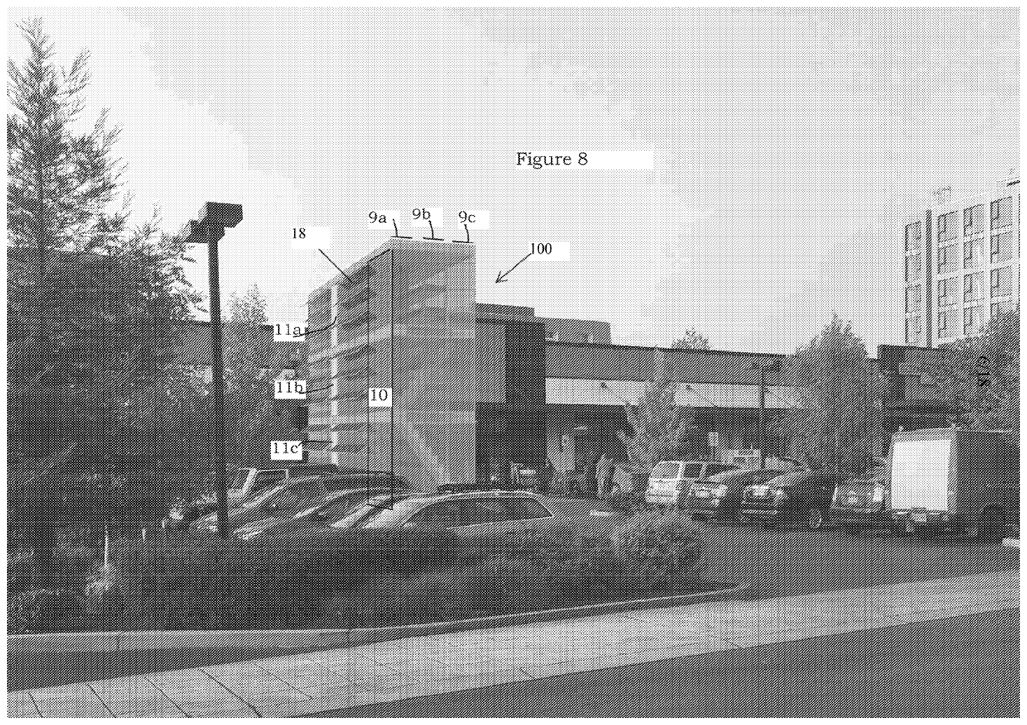

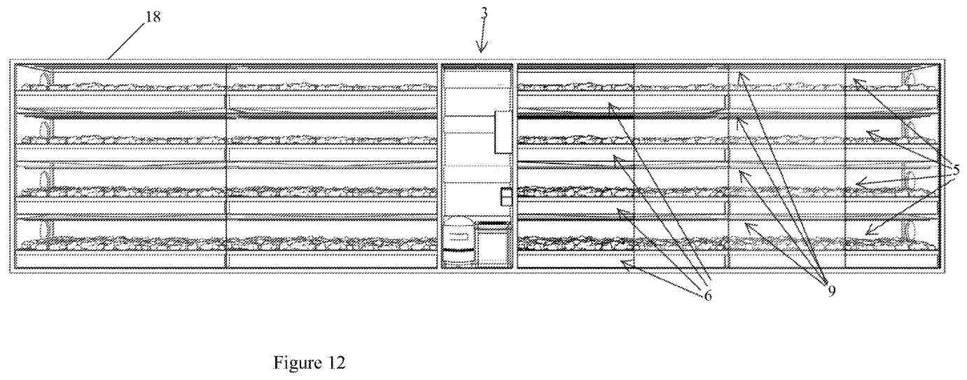

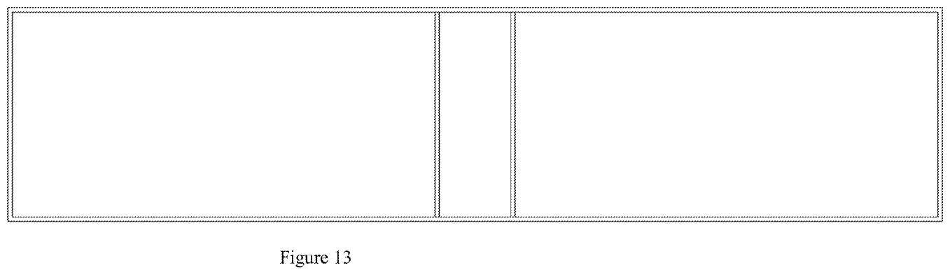

Within each unit, there are a plurality of horizontally-oriented vegetation spaces 5, each vegetation space 5 being above a root chamber 6. Root chambers 6 may be each removable from the unit, opaque, and enclosed to provide a moist and sanitary environment for plant root growth. The top of each root chamber has a plurality of circular openings 7 designed to hold individual plants, as illustrated in FIG. 4. The top of the root chamber 6 is removable, allowing access to the interior of the root chamber 6. The part of each unit that houses the root chambers and plants may be referred to as a grow space, a growing zone, or a growing environment and is enclosed by a shell 8 (see FIGS. 8 and 9). Removing root chambers 6 from the system 100, or alternatively adjusting the relative spacing of root chambers 6, enables adjustment of the size of vegetation spaces 5 to accommodate plants of different heights or maturity. Within each root chamber 6, brackets (not shown) are configured to support an optional plastic grid (not shown) that may be used to support the weight of certain root vegetables such as those having an unusual size or shape. Each root chamber 6 may be supported on its ends, by one or more support beams, or by a shelf. The shelves or root chambers 6 may be adjustable to different heights within the grow space to allow for plants of different sizes and heights to be grown in the same module. In one embodiment, at least one root chamber 6 in a module is positioned with a short vegetation space for seed germination or seedlings and at least another root chamber 6 in the same module is positioned with a tall vegetation space for growing mature plants. In an example embodiment, plants are supported in vertical or non-horizontal root chambers. In the embodiment of FIG. 12, four root chambers 6 are provided, one on top of another, in the grow space on each side of the central box 3. Each root chamber 6 has a vegetation space 5 directly above and lighting 9 directly above the vegetation space.

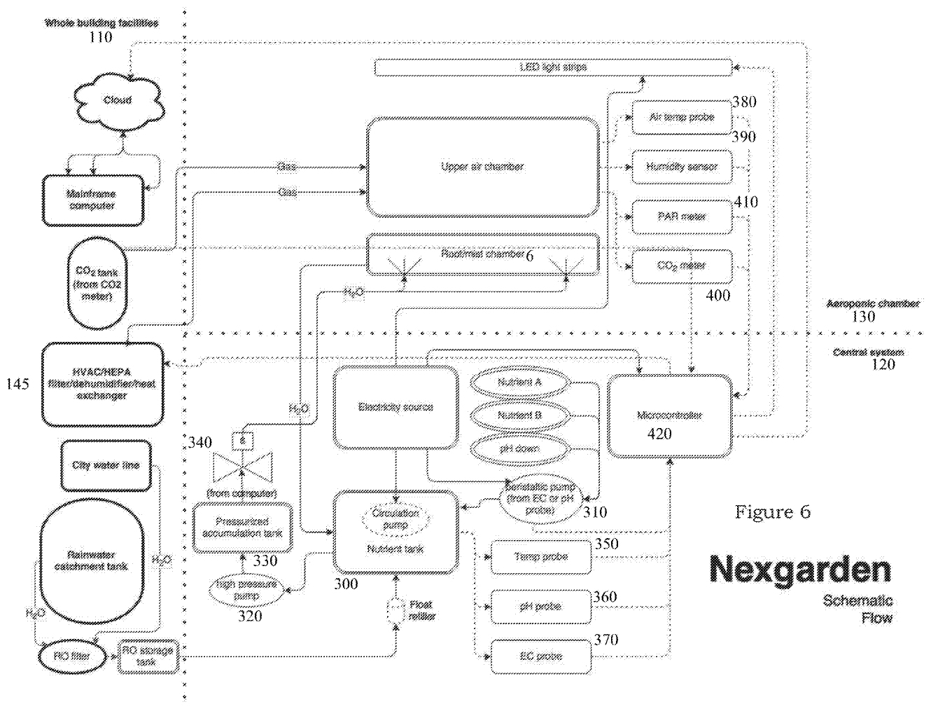

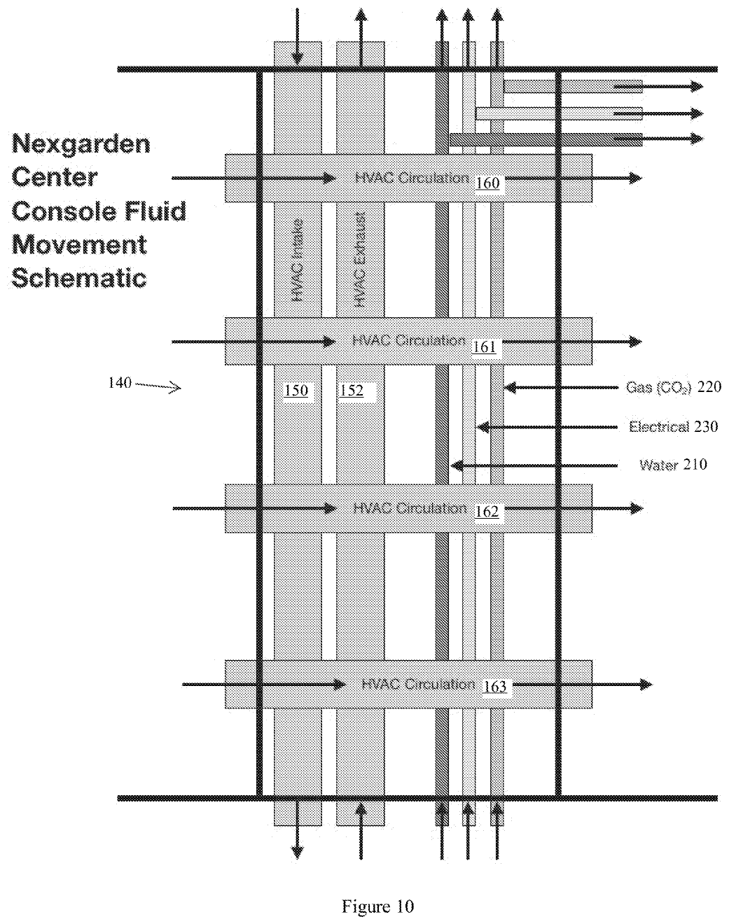

Farm-wide systems connect to each module to provide gas, water, light, nutrients, or other materials to promote plant health and growth. Farm-wide systems may connect at the central box 120 of the module or may connect at an end of the module. Examples of farm-wide systems may include carbon dioxide supply, air heating and cooling unit (HVAC) 145, filtered water supply, and reverse osmosis filter (drain water recoupment). As illustrated in FIG. 6, a central metered supply of carbon dioxide (CO₂) may provide carbon dioxide to growing zones 130 in each module via one or more gas conduit lines in the farm. Also, run-off water from each module may be dumped or drained into a catchment basin for filtering and recycling into the water supply of the farm. FIG. 6 provides a schematic illustration of farm-wide systems (or whole building facilities 110), central box systems (or central system 120), and grow space systems (or aeroponic chamber 130), according to one embodiment. FIG. 10 provides a schematic illustration of farm-wide systems at the central box 140 of the module, according to one embodiment.

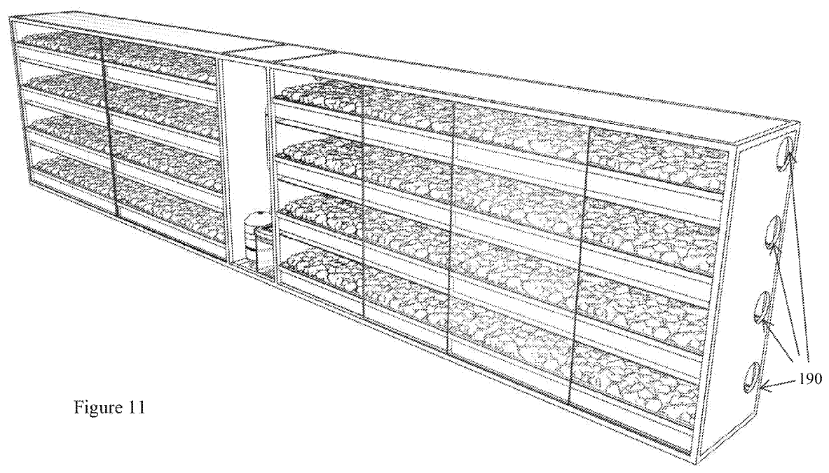

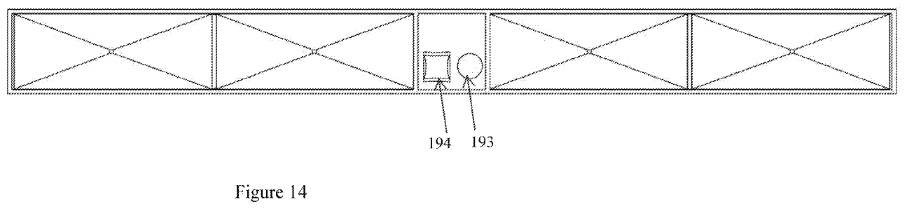

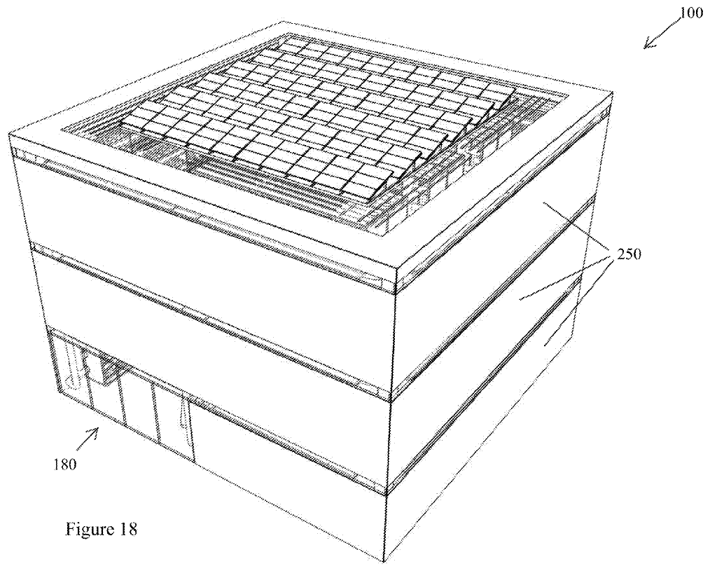

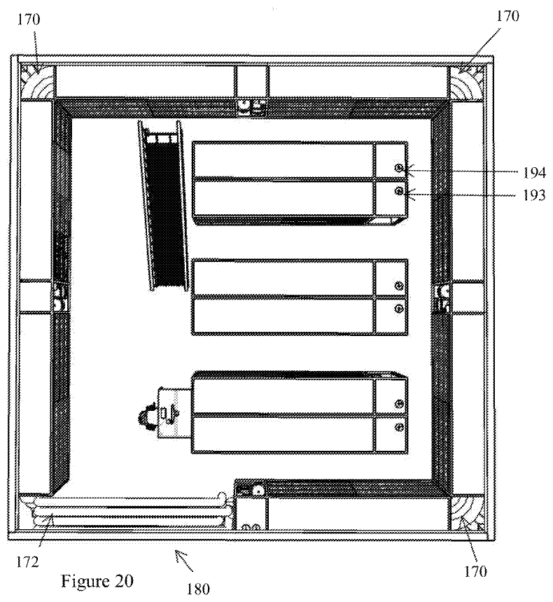

In an example embodiment, a farm-wide HVAC system 145 provides heating and cooling requirements for an entire farm. Air intake and exhaust ducts, such as ducts 150 and 152 in the embodiment of FIG. 10, travel vertically through a multi-story farm. In an example embodiment, the vertical air ducts travel through a subset of units on each floor, possibly only one unit on each floor, wherein the vertical air ducts connect with one or more floor-level air ducts that circulate conditioned air to each module on that floor, for example HVAC circulation ducts 160, 161, 162, and 163 in the embodiment of FIG. 10. In the embodiment of FIGS. 18-20, floor-level air ducts provide one or more air circulation paths along the perimeter of the building, passing through the length of each unit and connecting to an adjacent but orthogonal unit through a curved duct, for example corner ducts 170 as shown in FIG. 20. Additional ducting, such as ducts 172, may be provided to clear passageways such as building entry 180. In an example embodiment, each floor-level air circulation path is substantially horizontal and passes through all the vegetation spaces 5 of approximately the same height on that floor-level. In the embodiment of a growing unit shown in FIGS. 11-17, the unit has four holes 190 on each side to accommodate floor-level air ducts. In an example embodiment, each hole is filled with an air duct having a vent with an on/off valve such as a baffle or damper within the growing environment which enables air circulation for each vegetation space in a unit to be controlled separately from other vegetation spaces. As illustrated in FIG. 14 and FIG. 20, one or more apertures such as intake aperture 193 and exhaust aperture 194 may be provided in the central console of a module for the air intake and exhaust ducts to pass through the module. In one embodiment of a multi-story farm, air intake and exhaust ducts pass vertically through top and bottom holes in the central consoles of multiple modules (one on each floor) located directly above and below one another. In another embodiment, vertical intake and exhaust ducting is pre-installed in the central box of the module along with fittings or couplings for the intake and exhaust ducting located at the top and/or bottom of the module to facilitate an easy connection between units above and below. Intake air, whether from outside the building or from the interior of the building (but outside the internal growing environment of the modules), may pass through a HEPA filter (or equivalent) to remove contaminants before entering the system. Exhaust air, whether exiting the building or being exhausted into the interior of the building (separate from the internal growing environment of the modules), may pass through a heat exchanger or energy exchanger with dehumidifying coils. The heat exchanger conditions intake air with the exhaust air, thus bringing the intake air nearer to the desired temperature of the internal growing environment and improving energy efficiency.

In an example embodiment, dehumidifying coils condense moisture in the exhaust air, which drains into a rainwater catchment tank. In an example embodiment, the farm includes a rainwater drainage and collection system on the roof that also feeds into the rainwater catchment tank. In an example embodiment, the farm-wide water supply of the farm includes a rainwater catchment tank as well as main line water (e.g., city water supply). All water supply regardless of source may pass through a reverse osmosis filter before it is supplied to the modules. Water supply lines travel vertically through at least some units (like the air ducting), such as water supply line 210 in the embodiment of FIG. 10. In an example embodiment, the vertical water supply lines travel through a subset of units on each floor, possibly only one unit on each floor, wherein the vertical water supply line connects with a floor-level water supply conduit that provides water to each module on that floor. Units may include top and bottom holes through which the water lines pass. Or, in a different embodiment, a water supply line is pre-installed in the central box of the module along with fittings or couplings at the top and/or bottom of the module to facilitate an easy connection between units above and below. Within each unit, the water supply may connect via a one way valve to a nutrient tank located in each unit. In an example embodiment, the nutrient delivery system is a closed loop within each module, meaning that the modules do not need to be connected to a drain and that all run-off from the root chambers drains into the nutrient tank and is filtered and re-used. For periodic cleaning of nutrient tanks, the farm may include an open drain on each floor to empty nutrient tanks from each unit when needed.

In an example embodiment, a compressed CO₂ (gas) tank supplies carbon dioxide to all the modules in the building using gas lines separate from the air ducts or water supply. The gas lines may run alongside the HVAC ducts or the water lines. Gas supply lines may travel vertically through the units, such as gas supply line 220 in the embodiment of FIG. 10. Units may include top and bottom holes through which the water lines pass. Or, in a different embodiment, a gas supply line is pre-installed in the central box of the module along with fittings or couplings at the top and/or bottom of the module to facilitate an easy connection between units above and below. In an example embodiment, CO₂ delivery lines and valves are provided in each shelf or vegetation space within the unit, thereby facilitating separate control of CO₂ levels in each vegetation space.

In an example embodiment, a circuit breaker or other power control system supplies electrical power to all the modules in the building. Power lines may run alongside the HVAC ducts or the water lines. Power supply lines may travel vertically through the units, such as electrical power line 230 in the embodiment of FIG. 10. Units may include top and bottom holes through which the power lines pass. Or, in a different embodiment, a power supply line is pre-installed in the central box of the module along with fittings or couplings at the top and/or bottom of the module to facilitate an easy connection between units above and below. Similarly, electrical communication lines (not shown) for communicating with or controlling electronic devices of the module may link such devices to a farm-wide controller (described below) in lieu of wireless communications. In an example embodiment, lights, network devices, sensors, and other electronic devices are pre-installed within the module so that no additional wiring within the module is necessary. In an example embodiment, lights and wiring are provided in each vegetation space within the unit, thereby facilitating separate control of lighting levels in each vegetation space.

In one example embodiment, the soilless growing system 100 may be an aeroponic system. Aeroponic farming works by supporting each plant's roots in air and spraying the roots with a nutrient mist from below to keep the roots moist and to supply nutrients for plant growth. Alternatively, the growing system of the present disclosure may utilize other methods of soilless farming, including hydroponic systems. Hydroponic farming works by supporting each plant so that its roots are suspended in water. Filtering, circulation, and nutrient application in hydroponic water tanks may keep the roots moist and supply nutrients for plant growth. Both aeroponic and hydroponic methods support the upper section of the plant where the leaves reside above the wet root zone and illuminate the leaves with natural or artificial light or both to make photosynthesis possible.

FIG. 6 provides a schematic of the functions performed within the central box 120 of each module 1. Within the central box 120, pre-filtered water (through a reverse osmosis filter) enters a diluted nutrient tank 300. The water in this tank 300 has nutrient in it added from a two-part nutrient concentrate tank located within the central box 120. When the electrical conductivity probe reads an amount indicating that more nutrient is needed, a peristaltic pump (aka dosing pump) 310 is activated and adds a measured amount of concentrate to the diluted nutrient tank 300. The solution in this tank 300 is pulled out and through a particulate filter via a water pump 320 located outside of the tank 300 and pushed into an inline pressurized accumulation tank 330 and past a solenoid valve 340 that can be turned on or off by a controller, and finally through the root chamber 6 and out of misting heads located within the root chamber. The misting heads are oriented to spray outward onto the roots of the plants that are suspended from the circular openings 7 above the misting heads. Any nutrient solution that drains off the plant falls into a sloped catch tray beneath the roots and exits the root chamber 6 via gravity back into the nutrient tank where it is able to be filtered and recycled through the system again.

FIG. 6 provides a schematic illustration of one embodiment of a nutrient delivery system comprising a nutrient tank 300, peristaltic pump (aka dosing pump) 310, particulate filter, water pump 320, pressurized accumulation tank 330, solenoid valve 340, controller, misting heads, and catch tray. Other embodiments of a nutrient delivery system may omit the pressurized accumulation tank and misting heads in favor of hoses with drip apertures, gravity-feed water delivery, a hydroponic water tank in which plant roots are submerged, or other watering methods. These embodiments are illustrative and not limiting of a nutrient delivery system that may be used in a soilless farm according to the present disclosure.

A series of sensors are located in the grow space and the central box 120 of each module 1. Within the diluted nutrient tank 300 of the central box 120 are a water temperature probe 350, electrical conductivity (EC) probe 360, and pH probe 370. Within the grow space are an air temperature sensor 380 and humidity sensor 390, a CO₂ sensor 400, and a photosynthetically active radiation (PAR) sensor 410. All of these sensors have direct lines into a microcontroller 420 that then sends data to a computer located onsite, possibly via a wireless connection. Code in this computer monitors and adjusts inputs according to preset parameters. Examples of sensor feedback and environmental adjustments include the following. If pH is too low, a measured amount of pH adjustment solution is added to the diluted nutrient tank 300 via a peristaltic pump 310. If EC is too low, a measured amount of nutrient concentrate is added to the diluted nutrient tank 300 via a peristaltic pump 310. If temperature is too high or too low, or humidity is too high or too low, temperature and/or humidity of circulating air may be adjusted. In some embodiments, the farm-wide HVAC system 145 may adjust temperature and humidity of circulating air for the entire farm together, for different levels in a farm differently, or for different shelves in a module differently. In some embodiments, the central box 120 of each module may adjust incoming air from the farm-wide HVAC system 145 to control the climate of the entire module or to control the climate of different shelves in the module differently. Air circulation may be controlled in a variety of ways including dampers, baffles, or valves in the central box or in the growing space of the module. In an example embodiment, the climate control of each vegetation space 5 of a unit is controllable separately from other vegetation spaces of the same unit. For example, an air duct in a vegetation space may include an on/off valve that provides conditioned air to the vegetation space when open and provides no air when closed. If sunlight is illuminating the internal growing zone of a module or one or more vegetation spaces within the internal growing zone of a module, the intensity of the artificial lights in the growing space or in the one or more vegetation spaces may be lowered. If the CO₂ level within a grow space is too low, a solenoid valve may open to release additional CO₂ into the grow space. In one embodiment, sensor feedback for each module is processed by a controller housed in the central box of the module. In another embodiment, sensor feedback for each module is processed by a farm-wide controller. In yet another embodiment, feedback from a portion of the sensors for each module is processed by a controller housed in the central box of the module and feedback from another portion of the sensors for each module is processed by a farm-wide controller. In an example embodiment, adjustment of CO₂ levels, climate control (temperature and humidity), water temperature, pH, nutrient content, and light (aka active radiation levels), is made by valves, switches, and other control devices connected to a controller (whether farm-wide or module-based) and adjustable by the controller in response to sensor feedback. Module-specific control devices of farm systems may enable automated control of growing conditions including light, water, air, and nutrients specific to each module or even to each vegetation space within each module.

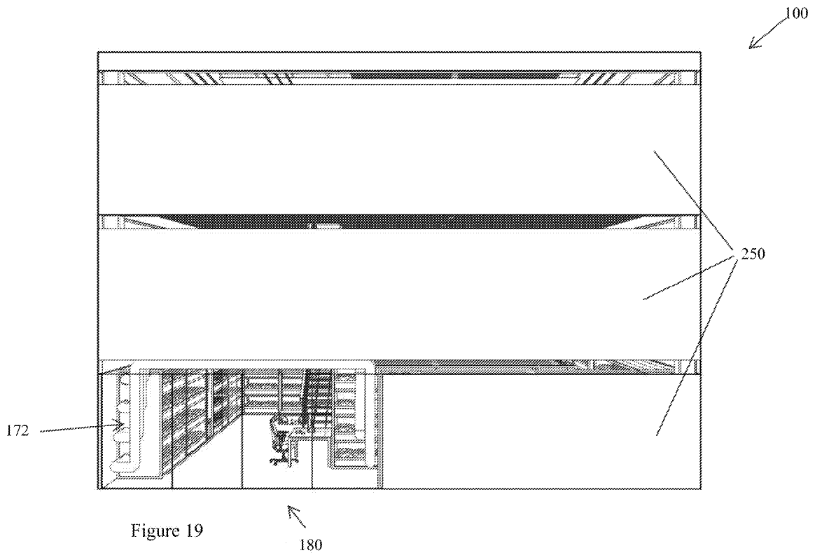

Embodiments of the present disclosure may include a translucent or transparent shell 18 that let sunlight in and reduce electrical light loads, as illustrated in the embodiment of FIG. 8. In other embodiments, the walls of the growing modules may be opaque to reduce the cost of climate control within the climate-controlled internal growing zone of the growing modules, as illustrated in the embodiment of FIG. 18. In one embodiment, the walls of the growing modules provide the exterior walls of a building. In an example embodiment, an outer building envelope encloses all the growing modules with a building. The envelope may be opaque or constructed from clear polycarbonate panels. The soilless farm shown in FIGS. 18 and 19 includes opaque paneling 250 that covers most but not all of the exterior of the building.

Each growing module includes artificial lighting, for example LED lights or fluorescent lights. In one embodiment, the growing environment is lighted by a combination of ambient sunlight and LED strip lighting. In one embodiment, solar panels 50 on the outside of the structure shade plants from direct sunlight while providing electricity to the system. Solar panels 50 may be automatically adjustable to track the sun and maximize electrical output during different seasons of the year. In another embodiment, plants are shaded by solar panels, or other opaque shielding, from harsh direct sunlight; this also limits excessive heat buildup inside the farm.

In an example embodiment, vertical beams located at the ends and middle of each unit are designed to support the weight of the root chambers, plants, and/or shelving inside the internal growing zone of the unit, including in some embodiments hydroponic or aeroponic root chambers. In an example embodiment, individual units are load-bearing such that the vertical beams located at the ends and middle of the unit are designed to accept the weight of at least four other units above them.

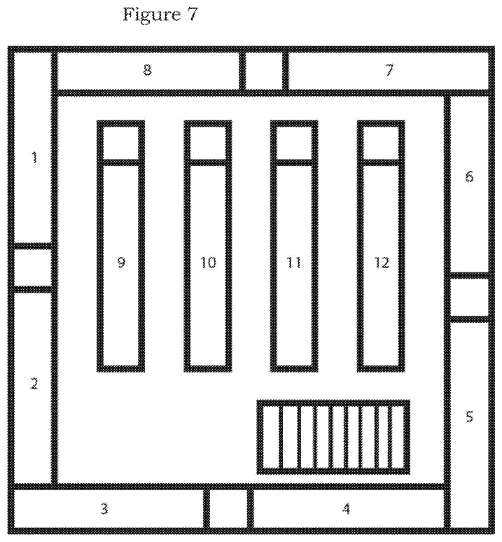

A complete farm plan may include a building design that meets engineering requirements for a multi-story structure. Such a design may include a building frame with a perimeter sized to match an arrangement of units. In the embodiment of FIG. 2, the perimeter of the farm matches an arrangement of four units in a square. In the embodiments of FIGS. 7, 9 and 20, the perimeter of the farm also matches an arrangement of four units in a square. In the embodiment of FIG. 8, the perimeter of the farm matches an arrangement of two units in a rectangle. The addition of an internal staircase at one end of the farm in FIG. 8 does not prevent the farm from being sized to match an arrangement of units. A floor plan may include a selected number of modules, for example, four or more full-size or half-size modules, per story. The floor plan of a single level or floor of a building may include perimeter modules around the entire perimeter of the floor as well as interior modules within the perimeter. As illustrated in the floor plans of the embodiments of FIGS. 7 and 20, half-sized units fit easily in the interior of a building whose outer walls are sized to match the length of a full-sized unit. In the embodiment of FIG. 7, four half-size units are spaced apart in the interior of the farm. Half-sized units in the building interior may be paired back to back so that the door of each unit is usable, allowing access to the internal growing zone of the unit. In the embodiment of FIG. 20, half-size units are paired back to back. As illustrated in FIGS. 19 and 20, replacing one full-size unit with a half-sized unit on the perimeter of the building can leave space for a passageway, such as building entry 180, large enough for a truck and other farming equipment to enter the building. A similar floor plan installed above the first story (also referred to as a level) may form a second story, and a similar floor plan installed above the second story may form a third story, and a similar floor plan installed above the third story may form a fourth story. The soilless farm of FIG. 8 has three levels. The soilless farm of FIG. 9 has four levels. The soilless farm of FIG. 18 has three levels. In an example embodiment, the units in the lower levels do not bear the weight of the upper levels. Instead, a building frame provides a floor for each level, and the units for each level of the building are installed on the respective floor for that level. A pre-approved building design may include internal or external load-bearing reinforcement structures, such as cross linking members, sheathing, cables, beams, and other structures, for resisting lateral shear forces, such as forces caused by wind or earthquakes.

In one embodiment of a farm, a concrete foundation is poured and a multi-story building frame is constructed using cross-laminated timber (CLT); other building frame materials may be suitable including steel and reinforced concrete. In an example embodiment, the internal dimensions of the building frame are substantially the same as the dimensions of an arrangement of growing units (for example as illustrated in the embodiments of FIGS. 2, 7, 9, and 11). On each story, a floor is built around the inside perimeter of the frame to support the three-foot deep footprint of the growing modules. Growing modules are placed on the floor on each level. Each module of the embodiment is connected to one or more adjacent modules on the same level, and one or more modules on each level are connected to modules directly above or below on an adjacent level. The connections may include one or more of electrical power, air circulation (e.g., air duct), water supply, drain water, and gas (i.e., CO₂).

One embodiment of a multi-story farm include a cargo elevator shaft for transporting harvested plants or waste from upper levels of the farm to the ground level. In one embodiment of a multi-story farm, sufficient floor space is provide in the interior of the farm to allow a harvesting machine to enter the building and operate a boom, ladder, or other extension for accessing the growing spaces of the modules with a harvesting machine. In one embodiment of a multi-story form, sufficient floor space is provided on each level of the farm for a cleaning and harvesting station.

With reference to FIG. 7, a example embodiment of the present disclosure includes a floor plan for a single level of a multi-level farm. FIG. 7 includes four full units including grow spaces 1, 2, 3, 4, 5, 6, 7, 8 and four half units including grow spaces 9, 10, 11, 12 on each floor, for a total of 12 grow spaces. The four full units 1, 2, 3, 4, 5, 6, 7, 8 form the exterior walls of the floor, and the four half units 9, 10, 11, 12 are placed in the interior of the farm. A staircase is shown in FIG. 7 to illustrate access to additional levels above or below the level shown. The floor plan of FIG. 7 is consistent with the design of the upper floors (not the ground floor) of the embodiment of FIG. 9, described below.

With reference to FIG. 8, an example embodiment of the present disclosure includes a multi-level farm, such as a three-level structure shown in FIG. 8. In FIG. 8, each level (or story or floor) is made of two units each running the length of the farm with a hallway between the units and an access space 10 at the end of the units for a staircase. The width of the farm includes the width 9a of a first stack of units and the width 9c of a second stack of units and the width 9b of the hallway between the units. On one face of the farm, three units are stacked 11a, 11b, and 11c to make the three-level farm. Each of the units 11a, 11b, and 11c has a central box and a grow space on each side of the central box. Each grow space has three root chambers stacked within the grow space, but this number could be changed to provide four or more root chambers in a grow space or to provide two or fewer root chambers in a grow space, depending on the height of unit, as well as to accommodate plants of different sizes.

With reference to FIG. 9, another example embodiment of the present disclosure includes a multi-level farm, such as a four-level structure shown in FIG. 9. In FIG. 9, the four exterior walls on each level (or story or floor) are each made of a single unit, each unit providing an outer wall of the farm so as to provide a four-sided farm. Four floors are provided in a stacked configuration; thus in FIG. 9 central boxes 40 of four stacked units are provided on a single side of the farm. Four units per floor and four floors makes 16 units forming the exterior walls of the example farm of FIG. 9. Each side of the farm has the dimension of the length of one unit 30 plus the width of one unit 36. In this embodiment, the units are sized the same such that length 30 of one unit and length 32 of another unit on a different side of the farm are the same. Each unit includes a central box with three root chambers extending laterally from opposite sides of the central box. FIG. 9 shows three root chambers 12a extending from one side of a central box for a unit on the fourth story, and three root chambers 12b extending from the opposite side of the same central box. Similarly, three root chambers 13 extend from one side of a central box on the third story, three root chambers 14 extend from one side of a central box on the second story, and three root chambers 15 extend from one side of a central box on the bottom (first) story. Each unit may be equipped with a clear polycarbonate sheathing (or shell) 18 to allow natural sunlight to penetrate the unit. Alternatively, the shell 18 is opaque. Alternatively or in addition, each unit may be equipped with solar panels 50 to create power for running the electronic pumps, controllers, sensors, HVAC, and other devices in the farm. A half unit 60 has root chambers on only one side of the central box and thereby leaves space on the other side of the central box for doors 61 that allow human access to the interior of the farm. The internal growing space of each unit is enclosed by shell 18 and is substantially airtight against the interior of the farm as well as the exterior of the farm. This arrangement separates the growing environment of each unit from the human access environment of the farm and thereby allows farm workers to perform a substantial number of tasks within the farm with minimal disruption to the growing environment. For example, a worker may open a unit, remove a root chamber from the unit, close the unit, and perform the tasks of loading or unloading plants from the root chamber outside of the growing environment. This improves upon prior systems that are designed for human access and work space inside the growing environment. By recognizing the value of eliminating or reducing the amount of human access in the growing environment, the present disclosure improves energy efficiency and sanitation in the growing environment.

It will be obvious to those having skill in the art that many changes may be made to the details of the above-described embodiments without departing from the underlying principles of the present disclosure. The scope of the present invention should, therefore, be determined only by the claims.

1. A soilless farm comprising
a plurality of farming units for growing plants, each farming unit comprising
a frame supporting a plurality of root chambers for growing plants;
a shell configured to surround the root chambers and to define an internal growing zone of the farming unit separate from a surrounding environment; and
a nutrient delivery system including a pump and a nutrient tank and designed to moisten plant roots in the plurality of root chambers,
wherein the shell comprises a plurality of apertures for connecting the farming unit to an adjacent farming unit via at least one of a fluid conduit and a power supply.

2. The soilless farm of claim 1, further comprising a building having a perimeter sized to match an arrangement of farming units inside the building.

3. The soilless farm of claim 2, wherein the building has multiple stories and a plurality of farming units on each story.

4. The soilless farm of claim 1, wherein the frame of each farming unit also supports a connection console separate from the internal growing zone, the connection console including a plurality of couplings for connecting the nutrient delivery system to at least one of a fluid conduit and a power supply.

5. The soilless farm of claim 1, further comprising a plurality of air circulation paths, each air circulation path passing through the plurality of farming units.

6. The soilless farm of claim 5, wherein the plurality of air circulation paths includes at least one air valve corresponding to the internal growing zone of each of the plurality of farming units to provide separate climate control for each internal growing zone in the farm.

7. The soilless farm of claim 6, wherein the plurality of air circulation paths includes at least one air valve corresponding to each root chamber of each of the plurality of farming units to provide separate climate control for each root chamber in the farm.

8. The soilless farm of claim 1, wherein the plurality of farming units substantially encloses an interior of a building.

9. The soilless farm of claim 8, further comprising a building envelope that surrounds the plurality of farming units.

10. The soilless farm of claim 8, wherein the interior of the building comprises one or more of stairs, elevators, ladders, scaffolding, catwalks, and other elevated structures for enabling human access to each farming unit from within the interior of the building.

11. A farming unit for building a soilless farm, the farming unit comprising:
a frame supporting a plurality of root chambers for growing plants;
a shell configured to surround the root chambers and to define an internal growing zone of the farming unit separate from a surrounding environment; and
a nutrient delivery system including a pump and a nutrient tank and designed to moisten plant roots in the plurality of root chambers,
wherein the shell comprises a plurality of apertures for connecting the farming unit to an adjacent farming unit via at least of one a fluid conduit and a power supply.

12. The farming unit of claim 11, further comprising a connection console separate from the internal growing zone, wherein the connection console includes a plurality of apertures for at least one of a fluid conduit and a power supply.

13. The farming unit of claim 11, further comprising:
a connection console separate from the internal growing zone; and
a plurality of couplings for connecting the nutrient tank to at least one of a fluid conduit and a power supply, wherein the nutrient tank is located in the connection console.

14. The farming unit of claim 11, further comprising:
a plurality of a vegetation spaces, each vegetation space adjacent to a root chamber of the plurality of root chambers;
a plurality of lights for illuminating the vegetation spaces; and
an electrical coupling for connecting the plurality of lights to a power source.

15. A method of constructing a soilless farm comprising:
arranging a plurality of farming units;
constructing a building wherein an internal perimeter of the building is sized to match the arrangement of the plurality of farming units, each farming unit including
a shell defining an internal growing zone of the farming unit separate from a surrounding environment; and
a connection console separate from the internal growing zone;
wherein the shell comprises a plurality of apertures for connecting the farming unit to an adjacent farming unit via at least one of a fluid conduit and a power supply; and
connecting each farming unit to a fluid conduit and a power supply.

16. The method of claim 15, further comprising forming a plurality of air circulation paths, each air circulation path passing through the plurality of farming units.

17. The method of claim 16, wherein each of the plurality of air circulation paths passes through one of the plurality of apertures for connecting the farming unit to an adjacent farming unit.

18. The method of claim 15, wherein the building has multiple stories and a plurality of farming units on each story.

19. The method of claim 18, further comprising forming a plurality of air circulation paths on each story, each air circulation path passing through the plurality of farming units on each story.

20. The method of claim 15, wherein each farming unit further includes a nutrient delivery system including a pump and a nutrient tank and designed to moisten plant roots in the internal growing zone, and wherein connecting each farming unit to a fluid conduit and a power supply includes connecting the nutrient tank of each farming unit to a water supply and a power supply.
